(19) United States
(12) Patent Application Publication
(10) Pub. No.: US 2013/0254041 A1
(43) Pub. Date: Sep. 26, 2013

(54) METHOD FOR DELIVERING FAIR ADVERTISING INVENTORY SPLITS GIVEN POSITION PREFERENCES

(71) Applicants: Jeffrey Sherwin, Scarsdale, NY (US); Nickolas James Heudecker, San Jose, CA (US); Matthew Narrell, Las Vegas, NV (US)

(72) Inventors: Jeffrey Sherwin, Scarsdale, NY (US); Nickolas James Heudecker, San Jose, CA (US); Matthew Narrell, Las Vegas, NV (US)

(21) Appl. No.: 13/427,934

(22) Filed: Mar. 23, 2012

(51) Int. Cl. G06Q 30/02

(52) U.S. Cl. 705/14.68

(57) ABSTRACT

A computer implemented method and system for enabling service providers to fairly distribute advertisement placement opportunities containing inventory splits is disclosed. A router receives a play list containing inventory split percentages of ownership of a number of placement opportunities. The router associates ownership of each of the placement opportunities at random, but weighted by the inventory split percentages. The router inserts the placement opportunities into designated time intervals of a stream. The router transmits the stream to a user.

### FIELD OF THE INVENTION

The present invention relates generally to service provider video networks, and more particularly to a method and system for fairly distributing advertisement opportunities having inventor splits of ownership to service provider video data streams.

### BACKGROUND OF THE INVENTION

Web pages connected to the Internet may be configured to provide add placement opportunities. When a user of the Internet accesses a commercial Web site, the user may be greeted with a popup advertisement, portions of the viewing screen occupied by fixed or animated advertisements, scrolling banners, or fixed or moving advertisements that appear when the user clicks on links or performs steps in a purchase. Internet advertisement opportunities appear based on space, time, content, and user context and may be highly non-linear (i.e., the user chooses to initiate the playing of content and in response, the content starts).

In contrast, traditional advertising for broadcast and cable television and radio has followed a linear model. Programming may be linear in the sense that a program begins and is streamed and in progress when a user chooses to view entertainment content. FIG. 1 illustrates the differences and similarities between a linear and a non-linear model. Entertainment content 2, when processed as a digital data stream over a cable network, may be divided into a number of time intervals. The time intervals 4 comprise the time reserved for the viewed program (content), such as “Golden Girls.” The intervals 6, 8, 10, represent sections of time reserved for advertisements or “avails.” These “avails” may be viewed as advertisement placement opportunities. As used herein, a “placement opportunity” was traditional called an avail and is sometimes referred to as a slot (spots into slots). A placement opportunity is a construct that represents an opportunity to insert an advertisement or entertainment content, and defines the rules for that opportunity, such as its duration, interactivity, ownership, and technical constraints.

As used herein, a “spot” is an ad placed in a placement opportunity.

As used herein, the term “binding” refers to an identification of signals and content within a placement opportunity (PO). PO's are frequently created for broad amounts of content that are not yet published (i.e., any show on TNT network in the evening). When the show airs and a signal is detected, the signal is bound to the relevant PO's for that show.

As used herein, the term “impression” refers to a showing of an ad to a single viewer. For example, if a 30 second spot is placed in 50,000 video-on-demand (VOD) streams and it is known that 30,000 of the streams actually played the ad, then 30,000 impressions of that ad have been generated.

As used herein, a “status notification” may be, but is not limited to, an HTTP call from a VOD server with a unique ID that was created when a decision was delivered.

As used herein, the term “break” refers to all of the space in a stream between entertainment content. For example, a group of 4 consecutive 30 second spots between 2 segments of “Two and a Half Men” may be considered as a single break.

As used herein, the term “position preference” refers to those breaks in a stream that are more preferable than others for inserting ads. For example, the first position and last position of a break, and the first and second breaks may be more desirable because of the likelihood of being viewed and or receiving attention. In a VOD or Unicast stream scenario, streams may be terminated early; therefore, breaks occurring earlier in a stream may be preferable positions.

In linear over-the-air or traditional cable TV broadcasting, each of the intervals 6, 8, 10 are known as breaks with no distinction of ordering. Advertisement time may occur before, during, or after the intervals 4 in the breaks, each break comprising a “pod,” each “pod” containing one or more “avails.” The list of programs and breaks may be received by a service provider in a schedule, and may provide additional information as to which entity, e.g., a network, an operator, or other entity, owns each of the avails. A traffic and billing system then reads the schedule and identifies which network, operator, or other entity has the right to place an advertisement during a particular avail of a given pod during a given break. Existing cable systems provide static sales—e.g., a 30 second spot in a particular geographic market which may be inserted into one or more of the breaks 6, 8, 10.

In non-linear systems, such as Video-on-Demand (VOD), the intervals 6, 8, 10 may take on new meanings. The interval 6 is called a pre-roll, i.e., the space in a video that occurs immediately after a user clicks to start a VOD video. The interval 10 is known as a post-roll, i.e., the space after all of the VOD video segments have finished playing. The intervals 8 may be mid-rolls, i.e., mini-breaks in the middle of a VOD video, or may be interstitials, i.e., pod-like locations between consecutive VOD video segments. All of the intervals 6, 8, 10 in such play lists are ripe for the insertion of advertisements, i.e., advertisement placement opportunities.

In the traditional model for the placement of ads in television programming, avails are specified by a simple combination of channel and time and decided weeks ahead of broadcast. However, new cable content delivery systems permit advertising spots of varying duration, permit different levels of interactivity (e.g., polling or linking) through the use of buttons on a remote control, may be defined by geography, etc. In a world where TV viewing is becoming increasingly non-linear (e.g., video-on-demand (VOD), networked-based personal video recorders (PVR), interactive programs), a key goal of advertisement opportunity placement systems is to determine how to define placement opportunities that are non-deterministic and manifest dynamically. Advanced advertising needs to accommodate advertisement placement opportunities that are invoked by user events, which may include anything from playback of a VOD title to pausing one's DVR. As the scope of potential placement opportunities expands accordingly, it becomes necessary to precisely define those placement opportunities with attributes representing relevant business rules. These may be used to specify such things as inventory splits, quantity, duration, and position of ad breaks (pre-roll, mid-roll, post-roll); placement of pause ads and overlays; and levels and types of interactivity.

On the Internet, a content publisher and an advertiser may be isolated from one another, with an advertising network acting as an intermediary. On TV, the advertising network was formerly the national network, the cable network, or the cable operator, that had fixed avails. However, emerging advanced advertising standards for dynamic television provide an opportunity for content providers to derive value from a cable operator's ad placement infrastructure by creating new and more flexible advertising inventory (i.e., Potential Viewership*Placement Opportunities=Advertising Inventory). This new business model imposes unique technical challenges: unlike the Internet, where browsers access/display content and then are separately “referred” to a shared ad network, the cable television infrastructure selects and assembles both the advertisement and the content together in the network and delivers the combined result to customers' set top boxes. For this to work, cable television advanced advertising networks may need to at least partially operate within the infrastructure of a Multiple System/Service Operator (MSO—a cable TV organization that owns more than one cable system and may prove broadband Internet service). To achieve optimal addressability and user experience and achieve bandwidth efficiencies, advertising service elements and digital delivery components need to be located close to the edge of a network, i.e., at or near set top boxes. Decisions need to be made based upon relevant context (infrastructure, platform, content, geography, demographics, etc), which are applicable to non advertisements as well (e.g., suggested content). By making placement decisions and insertions at the time of a user request—or even at the appropriate times during content playout—fully dynamic ad placement may be achieved.

MSOs and Content Networks often share ad space or inventory in a video streams. As described above, placement opportunities on broadcasted streams may be delineated by distinct 30 second spots where each owner can place an ad from their media business. In Unicast streams where the same video may be watched by multiple parties, placement opportunities may be “split” among one or more MSOs and/or Content Networks according to agreed-upon percentages. These so-called “percentage splits” or “inventory splits” may be agreed to by the MSO and a Content Network (e.g., 20% is for the MSO), wherein, for example, an MSO may be granted 20% of the avails. A problem arises when an agreed upon percentage split of the number of avails in a given video stream is not a whole number. For example, for content that has six, 30 second spots, 20% is more than one spot but less than two spots. Conventionally, fair distribution may be achieved over a number of streams. For example, a 20% split may be achieved by providing the MSO 6 with spots of 5 streams (5 streams, at 6, 30's=30, 30's, and 20% is a whole number, 6). Unfortunately, it is not always possible to guarantee a consistent distribution of avails in a fair manner over a number of data streams in a highly non-linear video environment, such as VOD, or when certain of the avails are more preferable than others in a stream (e.g., the first, second, and last avail).

Accordingly, what would be desirable, but has not yet been provided, is a method and system for fairly distributing advertisement placement opportunities given inventory splits that may contain position preferences.

### SUMMARY OF THE INVENTION

The above-described problems are addressed and a technical solution is achieved in the art by providing a computer implemented method and system for enabling service providers to fairly distribute advertisement placement opportunities containing inventory splits. A router receives a play list containing inventory split percentages of ownership of a number of placement opportunities. The router associates ownership of each of the placement opportunities at random, but weighted by the inventory split percentages. The router inserts the placement opportunities into designated time intervals of a stream. The router transmits the stream to a user.

In an embodiment, the inventory split percentages may be temporarily over-weighting or under-weighting if measured percentages of types of placement opportunities diverges from the inventory split percentages by a predetermined percentage. An amount of over-weighting or under-weighting the inventory split percentages may depend upon a length of time taken for a status notification to be reported. The measured percentages of types of placement opportunities may be based on measuring a number of impressions delivered. The number of impressions delivered may be based on at least one of measuring a number of requests for placement opportunities, measuring actual split percentages of types of placement opportunities, and calculating percentages of placement opportunities based on received status notifications. The measured percentages of types of placement opportunities may be based on at least one of inventory policy context and asset and policy of an individual placement opportunity.

In an embodiment, the router may receive at least one ad decision, where associating an owner with at least one of placement opportunities is further based on the at least one ad decision.

In an embodiment, the router may request the placement opportunities from an embedded POIS or external POIS and providing at least one ad decision server with a placement opportunity. The types of placement opportunities may comprise content and an advertising placement opportunity. Content may comprise video, audio, or an interactive overlay.

In an embodiment, designated time intervals for placement opportunities may correspond to breaks, pre-rolls, post-rolls, mid-rolls, interstitials, pauses, and video-on-demand requests. A type of advertising placement opportunity may be a shuffle placement opportunity or a non-shuffle placement opportunity. A shuffle placement opportunity is a placement opportunity where a placement policy designates that any one of a plurality of owners of a placement opportunity space depends on the inventory split percentages.

In an embodiment, the stream may include at least one positional preference. The inventory split percentages may be inclusive or exclusive of the at least one positional preference. In an embodiment, the router may receive an inventory policy. The inventory policy may include designating at least one shuffle placement opportunity. Selecting an owner of the shuffle placement opportunity may be independent of positional preferences set in the inventory policy.

In an embodiment, the system may publish content covered by the inventory policy and bind the shuffle placement opportunity to a signal of the stream.

### BRIEF DESCRIPTION OF THE DRAWINGS

The present invention will be more readily understood from the detailed description of exemplary embodiments presented below considered in conjunction with the attached drawings, of which:

FIG. 1 is a diagram depicting the contents of a cable video data stream in the prior art and illustrating differences and similarities between a linear and a non-linear model;

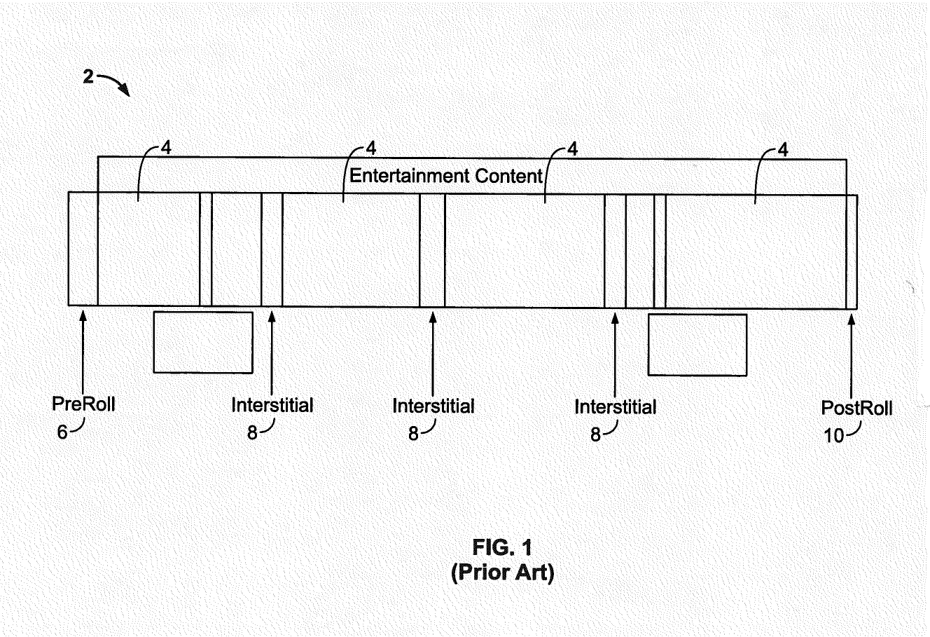

FIG. 2 depicts a configuration of a system for enabling service providers to fairly distribute advertisement placement opportunities having inventory splits, according to an embodiment of the present invention;

FIG. 3 is a flow diagram illustrating one embodiment of a method for generating an inventory split of content, according to an embodiment of the present invention;

FIG. 4 is a flow diagram illustrating one embodiment of a method for enabling service providers to fairly distribute advertisement placement opportunities having inventory splits, according to an embodiment of the present invention;

FIG. 5 is an illustration of an inventory split, where there are 7 avails, the first avail being reserved for a national content provider; and

FIG. 6 illustrates a diagrammatic representation of a machine in the exemplary form of a computer system within which a set of instructions, for causing the machine to perform any one or more of the methodologies discussed herein, may be executed.

It is to be understood that the attached drawings are for purposes of illustrating the concepts of the invention and may not be to scale.

### DETAILED DESCRIPTION OF THE INVENTION

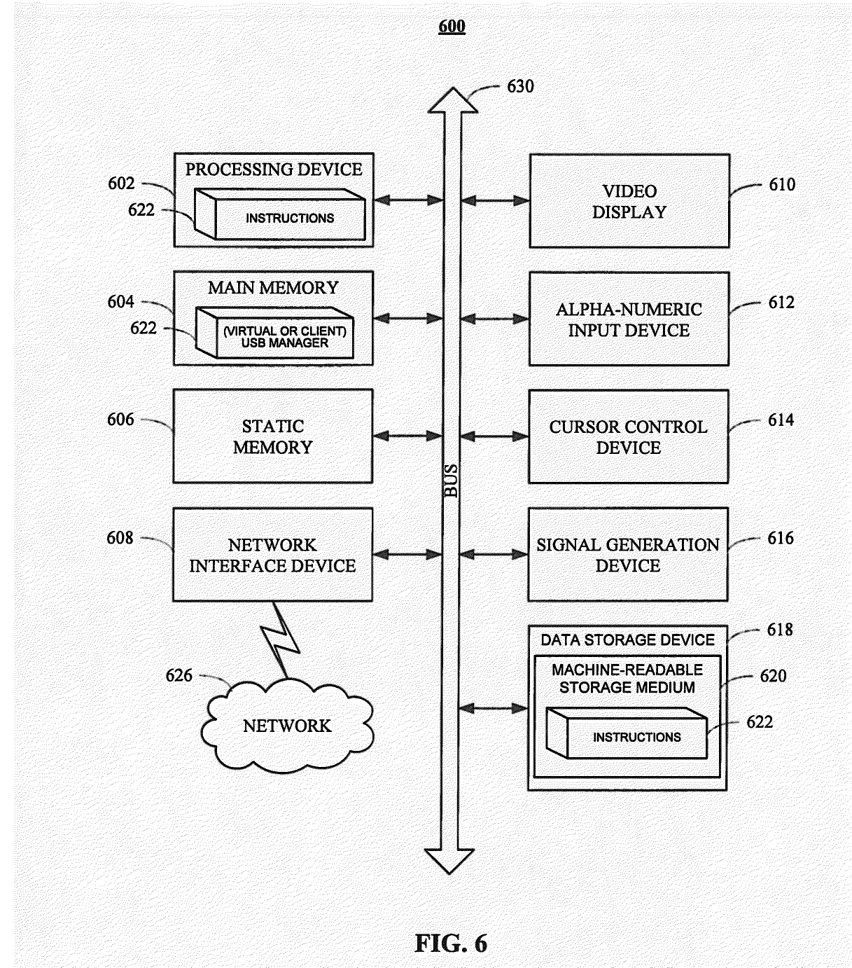

The term “computer” or “computer platform” is intended to include any data processing device, such as a desktop computer, a laptop computer, a tablet computer, a mainframe computer, a server, a handheld device, a digital signal processor (DSP), an embedded processor (an example of which is described in connection with FIG. 6), or any other device able to process data. The computer/computer platform is configured to include one or more microprocessors communicatively connected to one or more non-transitory computer-readable media and one or more networks. The term “communicatively connected” is intended to include any type of connection, whether wired or wireless, in which data may be communicated. The term “communicatively connected” is intended to include, but not limited to, a connection between devices and/or programs within a single computer or between devices and/or separate computers over a network. The term “network” is intended to include, but not limited to, OTA (over-the-air transmission, ATSC, DVB-T), packet-switched networks (TCP/IP, e.g., the Internet), satellite (microwave, MPEG transport stream or IP), direct broadcast satellite, analog cable transmission systems (RF), and digital video transmission systems (ATSC, HD-SDI, HDMI, DVI, VGA), etc.

The one or more computer readable media may be used for storing the instructions to be executed by the one or more processors, including an optional operating system, such as the Windows or the Linux operating system. The computer readable media may further be used for the storing and retrieval of data in one or more databases. The computer readable media may include a combination of volatile memory, such as RAM memory, and non-volatile memory, such as flash memory, optical disk(s), and/or hard disk(s). Portions of the data stored in the computer readable media may be provided by one or more human users at one or more monitors. The monitor (s) may be equipped with a keyboard and a mouse for selecting objects of interest by the user or for inputting data.

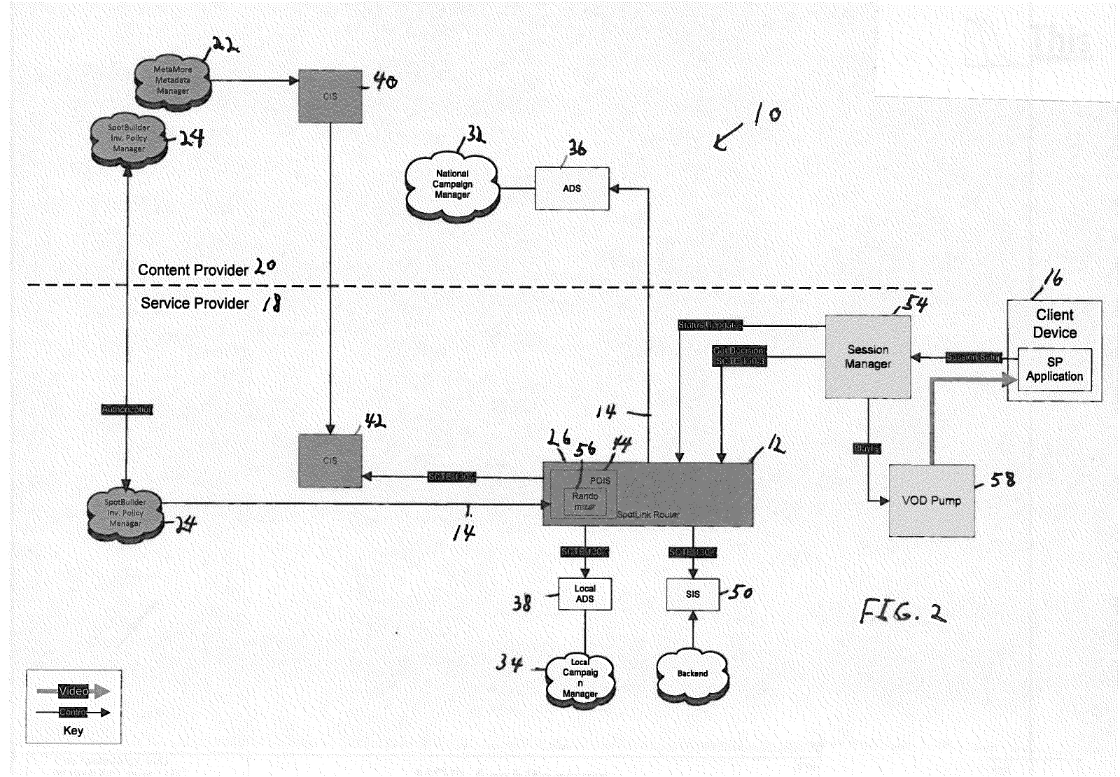

FIG. 2 depicts a configuration of a system 10 for enabling service providers to fairly distribute advertisement placement opportunities having inventory splits, according to an embodiment of the present invention. The system 10 may be executed on one or more computer platforms 12, interconnected by one or more networks 14 communicatively connected to client devices 16. The system 10 implements a number of logical functional blocks that may be distributed between one or more service providers 18 (e.g., video, audio, etc.) and content providers 20 (e.g. video, audio, etc.).

In an embodiment, the system 10 may be embodied in three products available from This Technology, Inc. of New York, N.Y.: the MetaMore metadata manager module 22 (hereinafter the “metadata manager 22”), which is described in detail in co-pending, commonly owned, U.S. patent application Ser. No. 12/274,906, filed Nov. 20, 2008, which is incorporated herein by reference in its entirety; the SpotBuilder inventory policy manager module 24 (hereinafter the “inventory policy manager 24”); and the SpotLink router 26 (hereinafter the “decision router 26”), communicatively connected to each other as shown.

The metadata manager 22 is an application server module for managing metadata. The metadata manager 22 permits content provider 20 or service provider 18 to ingest, edit, and distribute video metadata for VOD, advertising content, linear content, and network content for QAM and IP delivery platforms. The metadata manager 22 is a metadata management service configured to support single data source and multi-platform metadata translation.

Product features of the metadata manager 22 may include, but are not limited to, those listed in Table 1 below:

TABLE 1
Web-based tools for managing and searching including asset metadata including guide,
billing, license window and distribution information
Season templates and episodic content
Advertising traffic for network feeds
Linear metadata
Signal metadata
Reports that can be exported to an Excel spreadsheet
Supports multi-platform and multi-data model metadata translation
Creates video metadata in the following formats: CableLabs ADI 1.1, CableLabs ADI 3.0
Ingests and edits video metadata in the following formats: CableLabs ADI 1.1, CableLabs
ADI 3.0, MRSS, Strata One Source linear data
Tribune channel data
Exports metadata in the following formats: CableLabs ADI 1.1, CableLabs ADI 3.0, RSS 2.0
Supports the following standard data models: CableLabs ADI 1.1, CableLabs ADI 3.0
Is platform agnostic and customer application independent; functions as a single data source
Standards compliant SCTE 130-4 2009 Content Information Service (CIS) interface support-
ing queries, notifications and cursors
Supports distributed media availability status through the CIS appliance
And integrates with This Technology's SpotBuilder (e.g., the inventory policy manager 24)
and SpotLink Router (e.g., the decision router 26) for faster, more efficient ad insertion and
management

Product functions of the metadata manager 22 may include, but are not limited to, those listed in Table 2 below:

TABLE 2
Creates, reads, updates and deletes content metadata for supported platforms
Performs content information query support using SCTE 130-4 for real-time decision making
Provides native key/value metadata search including SCTE 130-4 regular expression (regex)
value matching
Includes a next-generation metadata management interface that stores, translates and tracks
content across all platforms and makes metadata available and accessible to all solutions
Provides signal marker management so consumers can enter and manage signal points
Manages and translates between multiple On Demand data models and linear metadata
Tracks availability of metadata and content across downstream endpoints
Includes master to master mode redundancy when fronted by a hardware load
Generates and continually updates advertising rights data sent to the realtime Metadata Engine
(RME), which is part of the CIS appliance (the RME queries this data to provide a CIS service
to advanced advertising systems in the real-time advertizing decision process)
Offers high availability and responsiveness

In an embodiment, the metadata manager 22 may be configured to provide dynamic advertising or content placement opportunities within digital video data streams. The metadata manager 22 is vendor and system agnostic, offering dynamic delivery of play lists (i.e., a video stream that comprises content and opportunities for advertisements), advertising avails, and related metadata. The metadata manager 22 is compatible with industry-wide advertising sales and delivery systems, including campaign managers (e.g., the national campaign manager 32 and the local campaign manager 34), content streamers (not shown), and traffic and billing systems (not shown). The metadata manager 22 provides management of play lists, which may comprise rules-based video streams comprising specific entertainment content, such as a feature or several episodes within a series, and designated advanced advertisement insertions, including breaks, entertainment content, pre, post, mid rolls, interstitials, interactives, and channel tunes.

The metadata manager 22 provides advertising placement opportunity management based on the SCTE-130 and CableLabs ADI1.1 and 2.0 standards for video-on-demand (VOD) (ADI will be defined hereinbelow) and the SCTE-118 standard for linear content, and the ability to apply the standards within a play list based on position, ownership, and sales rights. The metadata manager 22 provides distribution of play lists and schedules across multiple endpoints, effectively reducing the switching costs of campaign managers and ad decision servers (e.g., the ADS 36 and the local ADS 38).

The SCTE-130 standard provides a standardized and extensible message based interface defining a minimal set of cooperating logical services necessary to communicate placement opportunities, placement decisions, and placement related event data necessary for accountability measurements. SCTE-130 defines an extensible framework of interfaces among a set of advertising system logical services. The SCTE-130 standard encompasses: a minimal set of cooperative logical services needed to implement advanced addressable advertising systems; the core data types and extensible message framework forming a vocabulary needed to communicate among the defined logical services; the interfaces among these logical services using the core data types and messages; and, mechanisms for extensibility that allow innovation while preserving backward compatibility with already deployed systems—thereby reducing the complexity for incorporating new features within the standard.

The normative parts of the SCTE-130 standard define mechanisms for integrating systems implementing features such as VOD-based advertising, linear-based advertising, enhanced advertising capabilities such as ad rotation groups (rotation groups refer to placement opportunities that run in rotation so that the same add is not viewed again immediately), subscriber-based addressing for advertising or content tailoring, extension points for more advanced advertising or addressing features, logical services that are implemented as one or more physical systems created by the same vendor, deployment of a logical service that may simultaneously include systems from one or more vendors, and an implementation that may incorporate one or more of the defined logical services and interfaces

The SCTE-130 standard defines a set of logical services comprising an advanced advertising system. Each logical service may itself be a complex system. In an embodiment, one or more of the following logical services may be used by or interact with the metadata manager 22.

An Ad Management Service (ADM) (not shown) defines messages in support of ad insertion activities. The primary consumer of these messages is an Ad Decision Service (ADS—to be described below). The message interfaces exposed by an ADM permit both pre-configured ad decisions as well as real-time fulfillment models. An ADM implementation may incorporate some simple ad selection rules (e.g., ad rotations) but more complex ad decisions are the responsibility of an ADS.

An Ad Decision Service (ADS) (e.g., the ADS 36 and the local ADS 38) determines how advertising content is combined with non-advertising (i.e., entertainment) content assets. The decisions made by an ADS may be straightforward (i.e., specific ad content placed at a specific time in a specific asset) or arbitrarily complex (based on subscriber data, advertising zone, etc.).

The Content Information Service (CIS) (e.g., CIS 40, 42) manages metadata describing assets (both advertising assets and non-advertising assets) available to the other SCTE-130 logical services. The CIS provides query and notification interfaces to the other logical services. The query service is available on an ad-hoc basis and may be called by any other logical service at any time without any prior registration. Queries specify values or patterns to be sought in the query message metadata and the specified matching information (or an error indication) is returned in a response message.

The Content Information Service (CIS) is a storage and distribution engine. It stores metadata about entertainment and advertising assets; provides notifications to registered clients when metadata is modified; registers, receives and processes notifications from other CIS services; and supports real-time metadata queries. The CIS permits an Advertising Manager (ADM) and/or Ad Decision Service (ADS) to retrieve and utilize content metadata in their advanced advertising decision processing.

Product features of a CIS may include, but are not limited to, those listed in Table 3:

TABLE 3
A standards compliant SCTE 130-4 2009 CIS interface for supporting queries, notifications
and cursors
Support for the following standard data models: CableLabs ADI 1.1, CableLabs ADI 3.0,
and This Technology's Linear Data Model
Provides multi-platform and multi-data model metadata translation
Support for distributed media availability status
May be employed as a stand-alone storage and distribution engine or be bundled with
MetaMore (e.g., the metadata manager 22)
Integrates with This Technology's MetaMore (e.g., the metadata manager 22), SpotBuilder
(e.g., the inventory policy manager 24) and SpotLink Router (e.g., the decision router 26)
for faster, more efficient ad insertion and management
Platform agnostic and customer application independent
Functions as a single authoritative data source

Product functions of a CIS may include, but are not limited to, those listed in Table 4:

TABLE 4
Contains This Technology's realtime Metadata Engine (RME) for providing real-time query
support to advanced advertising systems engaged in real-time advertising decision processing
Performs content information query support using SCTE 130-4 for real-time decision making
Creates, reads, updates and deletes content metadata for supported data models and platforms
Provides native key/value metadata searching including SCTE 130-4 regular expression (regex)
value matching
Includes a next-generation metadata management interface that stores, translates and tracks
content across all platforms and makes metadata available and accessible to all solutions
Provides signal marker management allowing consumers to provide and obtain signal points
Manages and translates between multiple On Demand data models and linear metadata
Tracks availability of metadata and content across downstream endpoints
Operates as a fault tolerant master/master redundant cluster when fronted by a hardware network
load balancer
Persistent database scales are independent of the service's processing capability
Offers high availability and responsiveness

The Placement Opportunity Information Service (POIS) (e.g., POIS 44) may hold, maintain, and retain descriptions of placement opportunities. The POIS may also contain attributes and constraints for each placement opportunity, platform compliance, rights, and policies of the content in which the placement opportunity exists. These placement opportunities are content specific, therefore attributes and constraints may vary by network, geographic region, or other content distribution dimension.

The POIS is a Placement Opportunity (PO) storage and inventory execution engine. It stores PO metadata and statistics; provides notifications to registered clients when PO metadata is modified; registers, receives and processes notifications from other POIS services; and supports real-time PO metadata queries. Through the POIS appliance, an Advertising Manager (ADM) and/or Ad Decision Service (ADS) can retrieve and utilize placement opportunity metadata in their advanced advertising decision making.

Product features of a POIS may include, but are not limited to, those listed in Table 5:

TABLE 5
SCTE 130-5-compliant supporting real-time queries, notifications and cursors
Supports the SCTE 130-3 2010 Placement Opportunity Data Model (PODM), as well as service
provider custom data models
Can be used as a stand-alone engine or be bundled with SpotBuilder (e.g., the inventory policy
manager 24)
Platform agnostic and customer application independent
Integrates with This Technology's MetaMore (e.g., the metadata manager 22), SpotBuilder (e.g.,
the inventory policy manager 24) and SpotLink Router (e.g., the decision router 26) for faster,
more efficient ad insertion and management
Provides a well-defined workflow between Content and Service Providers
Enables Dynamic Advertising for defining inventory ownership independent of physical content
for multiple inventory owners; supports dynamic placement opportunity splits by ratio and
utilizes confirmation feedback, when available, for real-time rebalancing
Works with any SCTE 130-3-compliant ad management (ADM) or ad decision service (ADS)

Product functions of a POIS may include, but are not limited to, those listed in Table 6:

TABLE 6
Contains This Technology's RealTime Metadata Engine (RME) providing real-time query
support to advanced advertising systems engaged in real-time advertising decision processing
Performs placement opportunity query support using SCTE 130-5 for real-time decision making
Creates, reads, updates and deletes placement opportunity metadata
Provides native key/value metadata searching including SCTE 130-8 regular expression (regex)
value matching
Ensures that the single data set results in a standard set of outcomes across all networks,
geographies and device types, regardless of the local ad decision system in use
Manages advanced advertising inventory across all platforms by program, region, consumer
segment, time-part and device; informs a decision router (e.g., the decision router 26) when
inventory is available
Supports Ad Splits between parties as an independent authority and identifies local, marketing,
interconnect and national inventory for Pre C3, Post C3 and On Demand
Incorporates independent architecture and is highly scalable
Creates an abstraction layer between ad inventory and ADSs

The Subscriber Information Service (SIS) (e.g., the SIS 50) manages per-subscriber information relevant to ad placement decisions. The SIS provides mechanisms surrounding privacy issues.

In an embodiment, the metadata manager 22 as a software application focuses on the construction and distribution of play lists and schedules: entities that marry together opportunities for advertisements with content streams that make sense to viewers, operators, and content providers. Typically, the metadata manager 22 distributes this information to a downstream system, such as an ADS, ADM, or a Campaign Manager (e.g., the national campaign manager 32 and the local campaign manager 34) (or any combination thereof) which ultimately delivers content to an end user.

The ADI 1.1/2.0 package (not shown) is a software standard originating out of CableLabs which provides a means by which assets (content as well as metadata describing that content) are transported from a provider into an asset management system. ADI1.1 is currently the de facto standard, but will eventually be replaced by ADI2.0. The decorator (or content decorator) is a construct to house placement opportunities for the purposes of making mass changes based upon rules that may be matched to content to create play lists i.e., Content+Decorator=Play list or Schedule). A play list (schedule) is a video stream that comprises content and opportunities for advertisements. Delivered to an ADS/ADM integration point, a play list is turned into a stream of content and advertisements. Typically, the metadata manager 22 constructs and distributes play lists or schedules, i.e., entities that marry together opportunities for advertisements with content streams that make sense to viewers, operators, and content providers, to a downstream system, such as the ADS (e.g., the ADS 36 and the local ADS 38), the ADM (not shown), or a Campaign Manager (e.g., the national campaign manager 32 and the local campaign manager 34) (or any combination thereof) which ultimately delivers content to the end user.

Ad Units are created by the MetaMore system as the initial construct in support of a placement opportunity. Ad units are defined by duration, interactivity, and the number of subdivisions available.

The metadata manager 22 implements a POIS (e.g., POIS 44) compliant with SCTE-130 Parts 1-8. The POIS 44 holds, maintains, and retains descriptions of content placement opportunities (typically for advertisements) and provides the query interfaces and notifications for those opportunities. The POIS 44 contains features, attributes and constraints for each placement opportunity, compliant with platform, rights, and policies including those of the content in which it exists. These placement opportunities are content specific; therefore, attributes and constraints may vary by network, geographic region, or other content distribution dimension. The POIS 44 defines the standardized interface for accessing the placement opportunity information. The POIS 44 uses ADI2.0 and therefore needs to provide a mapping from ADI1.1 to ADI2.0. In one embodiment, the metadata manager 22 ingests ADI1.1, transform it (with field mapping), and output ADI2.0.

The inventory policy manager 24 offers the one or more content providers 20 and the one or more service providers 18 with a workflow-based platform to manage ad inventory rights for Linear, Time-Shifted, and On-Demand video content. The inventory policy manager 24 is a web based front end to a rules authoring tool for creating rules for creating placement opportunities.

Product features of the inventory policy manager 24 may include, but are not limited to, one or more web-based tools for managing the following listed in Table 7:

TABLE 7
ad units—defines an individual advertising space including its properties and constraints
avail templates—allows ad unit placement and sequencing along with additional property and
constraint definitions
stream groups—defines rules for identifying one or more assets as a group member
placement opportunity templates—enables avail templates to be applied to stream groups
creating placement opportunities

Other product features of the inventory policy manager 24 may include, but are not limited to, those listed in Table 8:

TABLE 8
Fully-featured SCTE 130-5-compliant POIS supporting the SCTE 130-3 2010 Placement
Opportunity Data Model (PODM), as well as service provider custom data models
Provides a well-defined workflow between Content and Service Providers
Enables Dynamic Advertising for defining inventory ownership independent of physical content
for multiple inventory owners; and supports dynamic placement opportunity splits by ratio and
utilizes confirmation feedback, when available, for real-time rebalancing
Unifies ad inventory across diverse network types such as, but not limited to: converges QAM
and IP advertising systems into one platform
Enables cross platform advertising
Coordinates different ad units within a single platform
Platform agnostic and customer application independent
Integrates with This Technology's MetaMore, POIS appliance, and SpotLink Router for faster,
more efficient ad insertion and management
Works with alternative metadata management systems for content and schedule metadata
Incorporates independent architecture and is highly scalable
Works with any SCTE 130-3-compliant Advertising Manager (ADM) or Ad Decision Service
(ADS)

Product functions of an inventory policy manager 24 may include, but are not limited to, those listed in Table 9:

TABLE 9
Service providers 18 can create and edit new ad units with the following information: designate
the ad's number of fixed, maximum and minimum placements; specify optimal, maximum and
minimum ad duration; specify the Interactivity and Overlay type; and, indicate whether or not
the ad is Addressable or Late Bound
Defines the ad units associated with a given piece of content
Ad unit rules include size, ownership, overlay, and interactive capabilities, and may be relevant
to certain zones, devices or time windows
Loads ad units into easy to use, highly flexible avail templates, which are applied to content and
contain the following information: unique names, content type and owner; ad units, location and
breaks; and, inventory ownership, specifying the ownership percentage between national and
local
manages advanced advertising inventory across all platforms by program, region, consumer
segment, time-part and device
Enables Content Providers to create, edit, delete, manage (publish and unpublish) and store
placement opportunities
Enables Service Provides to approve/disapprove, create, edit (including subdividing) and delete
placement opportunities
Providers can specify Avail Template and Stream Group rules in the PO Template to create,
read, update, delete, publish, distribute and unpublish placement opportunities
Supports Ad Splits between parties as an independent authority and identifies local, marketing,
interconnect, and national inventory for Pre C3, Post C3, and On Demand
Generates and continually updates advertising rights data sent to the RealTime Metadata Engine
(RME), which is part of the POIS appliance (the RME queries this data to provide a POIS
service to advanced advertising systems in the real-time advertising decision process)
Ensures that the single data set results in a standard set of outcomes across all networks,
geographies and device types, regardless of the local ad decision system in use

As used herein, an inventory policy may include the selection of some or all of the following data entries listed in Table 10:

TABLE 10
ad units (i.e. 30, 15, or 60 second spots)
number of ad units per break or layout of different break structure (1,2,3,4,n ads of ad type)
who owns which ads, including those marked as shuffle and percentages
which of those break patterns repeat for subsequent breaks that are in the stream (i.e., specify
break 1, 2, and repeat 3 and 4 for all breaks seen in content thereafter)
The application of that avail template to:
A selection of content by name, provider, or other metadata
A selection of content by region
A selection of content by play time
A selection of content by play device
A selection of content by other contextual data

The decision router 26 is a fully-compliant SCTE 130-3 intermediary transparently connecting delivery platform Advertising Management implementations (ADMs) with their counterpart Campaign Management System (CMS) Ad Decision Services (ADSs). The decision router 26 forwards ad decision requests to the correct decision owning ADS. This is accomplished through a configurable combination of classification, rules and policy that is enriched and supplemented by placement opportunity and content metadata. The decision router 26 also facilitates ad placement reporting by correctly managing and forwarding ad placement events to the rightful decision owners for campaign stewardship, reporting and billing.

Product features of the decision router 26 may include, but are not limited to, one or more web-based tools for managing the following listed in Table 11:

TABLE 11
Fully compliant SCTE 130-3 intermediary supporting SCTE 130-32010, including the
Placement Opportunity Data Model (PODM)
Works with any SCTE 130-3 compliant ADM or ADS
Provides intelligent ADS routing
Supports temporal ad locations: pre-roll, mid-roll and post-roll
Supports placement opportunity actions: fill, replace and delete
Supports both native SCTE 130 and enhanced play list mode response modes
Customizable business rules for placement request, placement response and placement status
notification message translation
Customizable ad placement request targeting criteria enrichment
Platform agnostic and customer application independent
Optionally integrates with This Technology's Data Boundary Manager (DBM) (not shown) for
restricting high valued data from being exchanged with third party ADSs
Supports multiple simultaneous instances of This Technology's VAST adapters (not shown) for
routing ad decision requests and placement status to broadband CMS s and their ADSs
Integrates with This Technology's Content Information Service (CIS) Appliance and Placement
Opportunity Information Service (POIS) appliance for faster, more efficient content and
placement opportunity metadata acquisition and utilization

Product functions of the decision router 26 may include, but are not limited to, those listed in Table 12:

TABLE 12
Supports both static and dynamic ADM and ADS endpoint registration
Custom classification for static ad placement routing decisions such as by provider identifier or
temporal location
The optional SpotLink DBM (not shown) enables service providers 18 to apply data access
policy to individual ad placement requests and placement reporting status notifications,
effectively controlling the flow of session and subscriber data to internal and external ad-serving
solutions. Through the SpotLink DBM, service providers 18 can provide local ad sales teams
with unique data access and create premium data offerings for national ad inventory owners
DBM restricts targeting criteria and other sensitive data from inclusion in Placement Request
messages
DBM restricts the event set forwarded when reporting ad placement results via the Placement
Status Notification message
Communicates with This Technology's CIS appliance, or any SCTE 130-4 CIS implementation,
through the SCTE 130-4 2009 interface to obtain content metadata and media availability.
Custom selection of content metadata may optionally enrich individual placement request
messages as targeting criteria refinement
Communicates with This Technology's POIS appliance, or any SCTE 130-5 POIS
implementation, through the SCTE 130-5 2010 interface to discover placement opportunity
metadata. Placement opportunity ownership metadata enables complex rules based routing
decisions for ad placement requests to be directed to the correct owner. Enhanced temporal
placement opportunity location metadata is instrumental in correctly locating and placing mid-
roll ad decisions
Operates as a fault tolerant master/master redundant cluster when fronted by a hardware network
load balancer providing high availability and responsiveness
Persistent event reporting database scales independently of the router's processing capacity

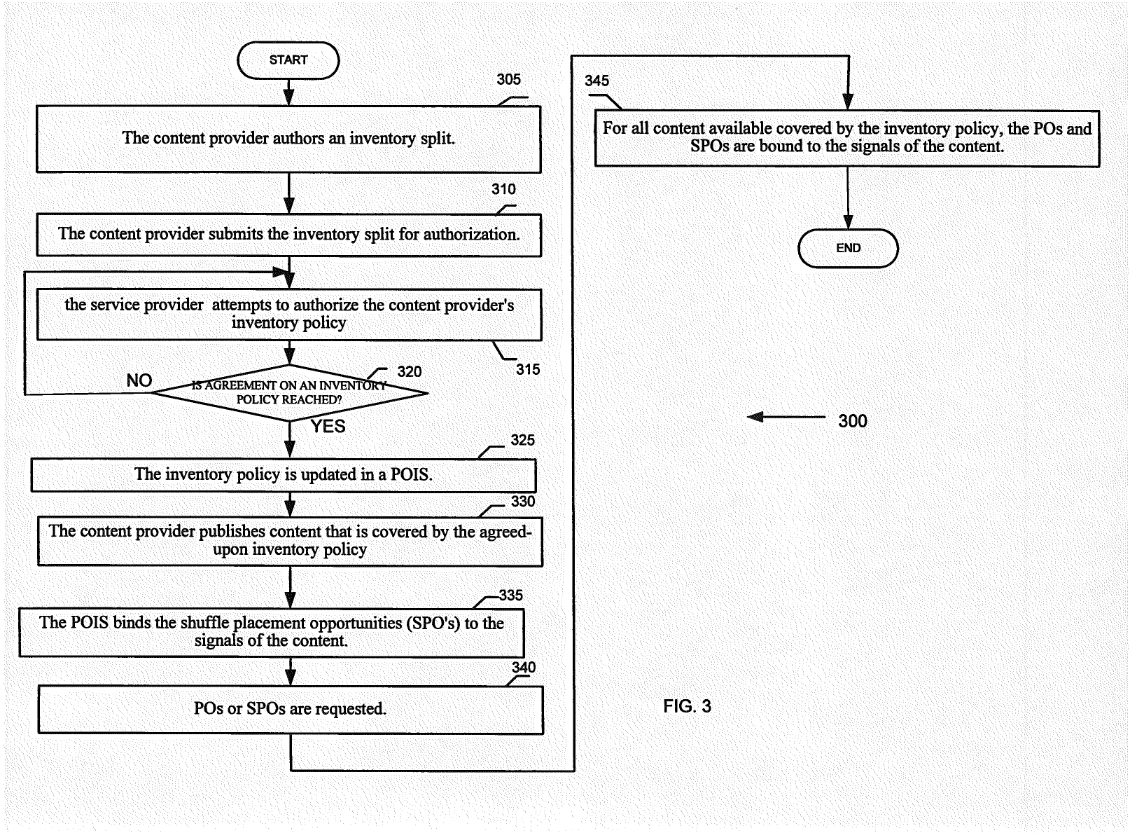

FIG. 3 is a flow diagram illustrating one embodiment of a method 300 for generating an inventory split of content, according to an embodiment of the present invention. Referring now to FIGS. 2 and 3, at block 305, the content provider 20 authors an inventory split in a portion of the inventory policy manager 24 associated with content provider 20. At block 310, the content provider 20 submits the inventory split for authorization to the portion of the inventory policy manager 24 associated with the service provider 18. The content provider 20 and the service provider 18 are only two of multiple parties that may be involved. At block 315, the service provider may then attempt to authorize the content provider's 20 (or any other counter-party's) inventory policy. As described above, the inventory policy may include, for example, positional preferences, ad loads, and inventory splits. At block 320, if agreement on an inventory policy is reached among the involved parties, then at block 325, the inventory policy is updated in the POIS 44, which, in an embodiment, may be within the decision router 26. At block 320, if agreement is not reached, processing returns to block 315.

An inventory policy may include inventory marked as, for example, a shuffle or “shuffle placement opportunity (SPO)”, meaning that either party may own this space depending on inventory split percentages, stream context, etc. The actual owner will be determined during a stream request.

At block 330, the content provider 20 publishes content that is covered by the agreed-upon inventory policy. At block 335, the POIS 44 binds the shuffle placement opportunities (SPO's) to the signals of the content. The POIS 44 has knowledge of the desired inventory load, split, and positional preferences for that content and others in the same context to which the inventory policy are applicable before any stream has ever been requested, and accordingly, at block 340, POs or SPOs are requested. At block 345, for all content available covered by the inventory policy, the POs and SPOs are bound to the signals of the content.

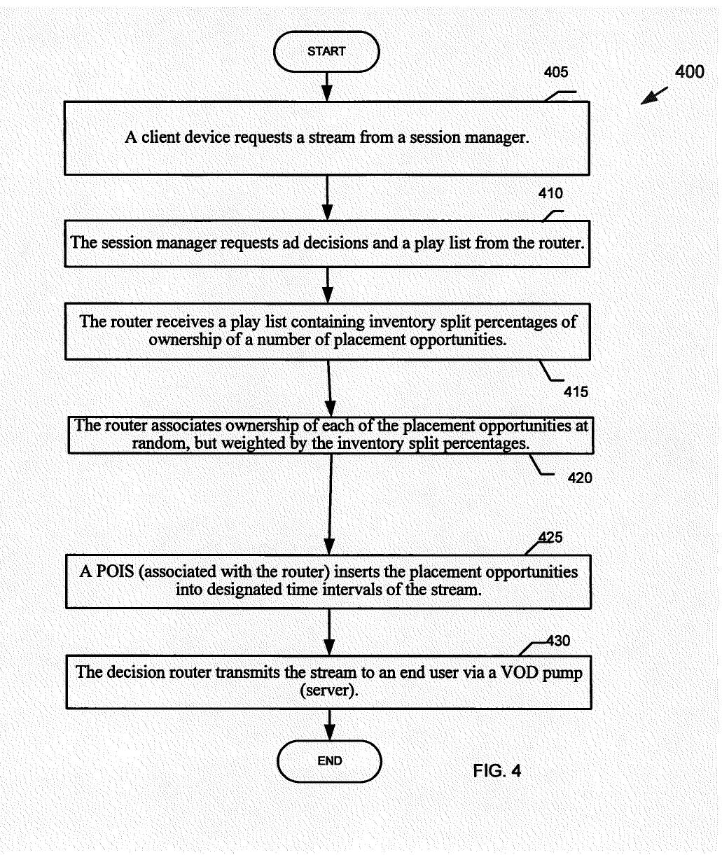

FIG. 4 is a flow diagram illustrating one embodiment of a method 400 for enabling service providers to fairly distribute advertisement placement opportunities having inventory splits, according to an embodiment of the present invention. At block 405, the client device 16 requests a stream from a session manager 54. At block 410, the session manager 54 requests ad decisions and a play list from the decision router 26. At block 415, the decision router 26 receives a play list containing inventory split percentages of ownership of a number of placement opportunities. At block 420, the decision router 26 associates ownership of each of the placement opportunities at random, but weighted by the inventory split percentages. More particularly, the decision router 26 requests POs from the embedded POIS 44 (or, in another embodiment, an external POIS) so that it can call each ad decision server ((e.g. the ADS 36 and the local ADS 38) with the right POs. If any of the POs are SPOs, the POIS may select the owner of the SPOs at random using an embedded randomizer 56, but weighted by the inventory split inclusive of or exclusive of any positional preferences already set in the inventory policy (in addition, inclusive or exclusive positional preferences may be determined by the inventory policy).

For example, if there are 5 SPOs (and no other POs) and the inventory split percentage is 20% for a minority owner, the minority owner's PO may be assigned to any one of the SPOs on average, and over time, should converge on 20% over all of the SPOs. Occasionally, the randomizer 56 may insert more than one minority owned PO in the stream, and occasionally, the randomizer 56 may include no minority owned POs in the stream.

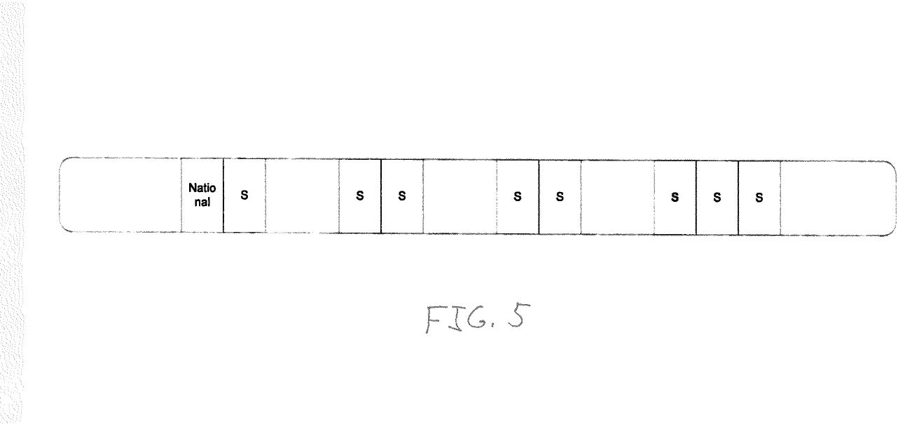

Since a single avail cannot be split (a 30 second spot is a 30 spot) for a single Unicast stream, if the percentage of total POs in the requested stream is not an integer, the split percentage actually returned by the POIS 44 will not match the policy percentage, yet an integral number needs to be retained. For instance, referring to FIG. 5, an illustration of an inventory split, where there are 7 avails, the first avail being reserved for a national content provider. If the split were 20% inclusive, theoretically, 1.4 slots belong to the minority owner. If the split were 20% exclusive, theoretically, 1.2 slots belong to the minority owner. Assuming that the split was exclusive, on average, at least one SPO should be a minority owned slot, and for every 5^{th} stream, two SPOs should be a minority owned spot, on average.

Returning to FIG. 4, at block 425, the POIS (associated with the decision router 26) may insert the placement opportunities into designated time intervals of the stream. At block 430, the decision router 26 transmits the stream to an end user via a VOD pump (server) 58.

A sophisticated POIS may maintain percentages by inventory policy context (i.e., all assets in context that match the inventory policy) or by asset and inventory policy (i.e., this asset under this inventory policy) or possibly by individual SPO. The POIS 44 may also factor in a measurement of actual impressions delivered if the status notifications by PO or decision are returned, since not all streams may be watched to completion (and some may be watched multiple times or none at all because of rewind and skip capabilities of the VOD pump 58). To achieve this, the POIS 44 maintains a measured number of requests for POs and the split percentage rendered, and the percentage of those POs actually seen based on status notifications.

In order to cause the actual percentage split to converge on the targeted percentage split, the POIS 44 may request the randomizer 56 to overweight or underweight the targeted (predetermined) percentage to drive the percentages closer together. If the actual percentage split diverges further, the POIS 44 may more heavily overweight or underweight the targeted (predetermined) percentage to seek the actual percentage. The amount to over or underweight the randomizer 56 may depend on how long the VOD server 58 takes to report status notifications.

The present invention is subject to numerous variations. For example, the network or the MSO may negotiate positional preference, for example: “the network always owns the first 30 of the first 2 breaks, and the MSO always owns the second 30 of the first break.” Additionally, percentage ownership may be calculated inclusive or exclusive of those position preferences. In the above example, if the remainder of the placement opportunities are marked as shuffle or random, the randomizer 56 may randomize to achieve a desired inventory split over all streams of that type (which may be affected by, for example, an 80/20 rule and positional preferences). To achieve the latter, each break start and end may be marked with an in-video (called in-band) cue tone (digital or analog) and/or a corresponding time code in metadata (usually in seconds·milliseconds offset from beginning of stream).

In addition, if the status notifications are available such that only portions of individual streams are watched (i.e., the end user terminated the stream before all the POs were presented), the POIS 44 may adjust the subsequent selection of owner POs to account for actual POs, not only those provisioned but not consumed. Continuing the example above, the system 10 may attempt to deliver 1.2 slots to the minority owner (inclusive of the first break), but on average, end users terminate viewing before the last break. If this is not factored in, the split appears to be 20%; if it is factored in, the split appears to be 8% (because 3 of 7 POs will never be viewed).

FIG. 6 illustrates a diagrammatic representation of a machine in the exemplary form of a computer system 600 within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a personal digital assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 600 includes a processing device 602, a main memory 604 (e.g., read-only memory (ROM), flash memory, dynamic random access memory (DRAM) (such as synchronous DRAM (SDRAM) or Rambus DRAM (RDRAM), etc.), a static memory 606 (e.g., flash memory, static random access memory (SRAM), etc.), and a data storage device 618, which communicate with each other via a bus 630.

Processing device 602 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. Processing device 602 is configured to execute the metadata manager 22, the inventory policy manager 24, and the decision router 26, communicatively connected for performing the operations and steps discussed herein.

Computer system 600 may further include a network interface device 608. Computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 616 (e.g., a speaker).

Data storage device 618 may include a machine-readable storage medium (or more specifically a computer-readable storage medium) 620 having one or more sets of instructions 622 (e.g., the metadata manager 22, the inventory policy manager 24, and the decision router 26) embodying any one or more of the methodologies of functions described herein. The metadata manager 22, the inventory policy manager 24, and the decision router 26 may also reside, completely or at least partially, within main memory 604 and/or within processing device 602 during execution thereof by computer system 600; main memory 604 and processing device 602 also constituting machine-readable storage media. The metadata manager 22, the inventory policy manager 24, and the decision router 26 may further be transmitted or received over a network 626 via network interface device 608.

Machine-readable storage medium 620 may also be used to store the device queue manager logic persistently. While machine-readable storage medium 620 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instruction for execution by the machine and that causes the machine to perform any one or more of the methodologies of the present invention. The term “machine-readable storage medium” shall accordingly be taken to include, but not be limited to, solid-state memories, and optical and magnetic media.

The components and other features described herein can be implemented as discrete hardware components or integrated in the functionality of hardware components such as ASICs, FPGAs, DSPs or similar devices. In addition, these components can be implemented as firmware or functional circuitry within hardware devices. Further, these components can be implemented in any combination of hardware devices and software components.

Some portions of the detailed descriptions are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the above discussion, it is appreciated that throughout the description, discussions utilizing terms such as “enabling”, “transmitting”, “requesting”, “identifying”, “querying”, “retrieving”, “forwarding”, “determining”, “passing”, “processing”, “disabling”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specially constructed for the required purposes or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory devices including universal serial bus (USB) storage devices (e.g., USB key devices) or any type of media suitable for storing electronic instructions, each of which may be coupled to a computer system bus.

The algorithms and displays presented herein are not inherently related to any particular computer or other apparatus. Various general purpose systems may be used with programs in accordance with the teachings herein or it may prove convenient to construct more specialized apparatus to perform the required method steps. The required structure for a variety of these systems will be apparent from the description above. In addition, the present invention is not described with reference to any particular programming language. It will be appreciated that a variety of programming languages may be used to implement the teachings of the invention as described herein.

It is to be understood that the above description is intended to be illustrative, and not restrictive. Many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

What is claimed is:

1. A computer-implemented method for enabling service providers to fairly distribute advertisement placement opportunities containing inventory splits, comprising the steps of:
receiving, at a router, a play list containing inventory split percentages of ownership of a plurality of placement opportunities;
associating ownership of each of the plurality of placement opportunities at random, but weighted by the inventory split percentages;
inserting the plurality of placement opportunities into designated time intervals of a stream; and
transmitting the stream to a user.

2. The computer-implemented method of claim 1, further comprising temporarily over-weighting or under-weighting the inventory split percentages if measured percentages of types of placement opportunities diverges from the inventory split percentages by a predetermined percentage.

3. The computer-implemented method of claim 3, wherein an amount of over-weighting or under-weighting the inventory split percentages depends upon a length of time taken for a status notification to be reported.

4. The computer-implemented method of claim 2, wherein the measured percentages of types of placement opportunities are based on measuring a number of impressions delivered.

5. The computer-implemented method of claim 4, wherein the number of impressions delivered is based on at least one of measuring a number of requests for placement opportunities, measuring actual split percentages of types of placement opportunities, and calculating percentages of placement opportunities based on received status notifications.

6. The computer-implemented method of claim 2, wherein the measured percentages of types of placement opportunities are based on at least one of inventory policy context and asset and policy of an individual placement opportunity.

7. The computer-implemented method of claim 1, further comprising receiving at the router, at least one ad decision, wherein associating an owner with at least one of the plurality of placement opportunities is further based on the at least one ad decision.

8. The computer-implemented method of claim 1, further comprising requesting the plurality of placement opportunities from an embedded POIS or external POIS and providing at least one ad decision server with a placement opportunity.

9. The computer-implemented method of claim 2, wherein the types of placement opportunities comprises content and an advertising placement opportunity.

10. The computer-implemented method of claim 9, wherein content comprises video, audio, or an interactive overlay.

11. The computer-implemented method of claim 1, wherein designated time intervals for placement opportunities corresponds to breaks, pre-rolls, post-rolls, mid-rolls, interstitials, pauses, and video-on-demand requests.

12. The computer-implemented method of claim 9, wherein a type of advertising placement opportunity is a shuffle placement opportunity or a non-shuffle placement opportunity.

13. The computer-implemented method of claim 12, wherein a shuffle placement opportunity is a placement opportunity wherein a placement policy designates that any one of a plurality of owners of a placement opportunity space depends on the inventory split percentages.

14. The computer-implemented method of claim 1, wherein the stream includes at least one positional preference.

15. The computer-implemented method of claim 14, wherein the inventory split percentages are inclusive of the at least one positional preference.

16. The computer-implemented method of claim 14, wherein the inventory split percentages are exclusive of the at least one positional preference.

17. The computer-implemented method of claim 1, further comprising receiving an inventory policy.

18. The computer-implemented method of claim 17, wherein the inventory policy includes designating at least one shuffle placement opportunity.

19. The computer-implemented method of claim 18, wherein selecting an owner of the shuffle placement opportunity is independent of positional preferences set in the inventory policy.

20. The computer-implemented method of claim 18, further comprising:
publishing content covered by the inventory policy and
binding the shuffle placement opportunity to a signal of the stream.

21. A computer system for enabling service providers to fairly distribute advertisement placement opportunities, comprising:
a memory;
a processing device, coupled to the memory, the processing device configured to:
receive a play list containing inventory split percentages of ownership of a plurality of placement opportunities;
associate ownership of each of the plurality of placement opportunities at random, but weighted by the inventory split percentages;
insert the plurality of placement opportunities into designated time intervals of a stream; and
transmit the stream to a user.

22. The computer system claim 21, wherein the processing device is further configured to temporarily over-weigh or under-weigh the inventory split percentages if measured percentages of types of placement opportunities diverges from the inventory split percentages by a predetermined percentage.

23. A non-transitory computer readable storage medium including instructions that, when executed by a processing system, cause the processing system to perform a method for enabling service providers to fairly distribute advertisement placement opportunities, comprising:
receiving, at a router, a play list containing inventory split percentages of ownership of a plurality of placement opportunities;
associating ownership of each of the plurality of placement opportunities at random, but weighted by the inventory split percentages;
inserting the plurality of placement opportunities into designated time intervals of a stream; and
transmitting the stream to a user.

24. The non-transitory computer readable storage medium of claim 23, further comprising temporarily over-weighting or under-weighting the inventory split percentages if measured percentages of types of placement opportunities diverges from the inventory split percentages by a predetermined percentage.
